(19) United States
(12) Patent Application Publication
(10) Pub. No.: US 2024/0222897 A1
(43) Pub. Date: Jul. 4, 2024

(54) ELECTRICAL TERMINAL FOR ELECTRICAL CONNECTOR ASSEMBLY

(71) Applicant: Lear Corporation, Southfield, MI (US)

(72) Inventors: Chao Fang, Shanghai (CN); Zhipeng Bai, Shanghai (CN)

(73) Assignee: Lear Corporation, Southfield, MI (US)

(21) Appl. No.: 18/381,235

(22) Filed: Oct. 18, 2023

(30) Foreign Application Priority Data
Dec. 30, 2022 (CN) 202211739654.7

(51) Int. Cl. H01R 13/05

(52) U.S. Cl. CPC H01R 13/05

(57) ABSTRACT

An electrical terminal for use in an electrical connector assembly includes a receptacle portion and a spring portion. The receptacle portion is formed from an electrically conductive material and includes an engagement arm having a support surface that defines a receptacle space. The spring portion is supported on the support surface of the engagement arm of the receptacle portion and is formed from an electrically conductive material. The spring portion includes a first end portion, a second end portion, and an intermediate portion extending between the first end portion and the second end portion. The intermediate portion includes a corrugation having alternating raised and lowered regions between the first and second end portions.

### BACKGROUND OF THE INVENTION

This invention relates in general to electrical connector assemblies that provide mechanical and electrical connections between electrically operated devices in electrical systems. In particular, this invention relates to an improved structure for an electrical terminal for such an electrical connector assembly that is well suited for conducting relatively high magnitudes of currents therethrough without undesirably affecting the amount of force needed to connect the electrical terminal to a mating electrical terminal.

Many electrical systems are known in the art that include one or more electrically operated devices. For example, most automobiles and other vehicles are provided with a variety of electrically operated devices for the comfort and convenience of a driver or occupant. Typically, each of these electrically operated devices is connected to a source of electrical energy (and/or other components of the electrical system) by one or more electrical conductors. In many instances, an electrical connector assembly is provided on either or both ends of each electrical conductor to facilitate the installation, removal, and service of the electrically operated devices.

A typical electrical connector assembly includes a housing (which is typically formed from an electrically non-conductive material) that supports an electrical terminal (which is typically formed from an electrically conductive material). The housing of the electrical connector assembly may also support an end of an electrical conductor that is connected to the electrical terminal to facilitate both mechanical and electrical connections with the other components of the electrical system. A wide variety of electrical connector assemblies are known in the art and have functioned satisfactorily for many years.

However, it is known that when an electrical connector assembly is used to conduct relatively high magnitudes of currents, the heat generated by such relatively high-magnitude currents may cause undesirable dimensional changes in the electrical terminal, which can adversely affect the performance of the electrical terminal assembly. Thus, it would be desirable to provide an improved structure for an electrical terminal for such an electrical connector assembly that is well suited for conducting relatively high magnitudes of currents therethrough without undesirably affecting the amount of force needed to connect the electrical terminal to a mating electrical terminal.

### SUMMARY OF THE INVENTION

This invention relates to an improved structure for an electrical terminal for such an electrical connector assembly that is well suited for conducting relatively high magnitudes of currents therethrough without undesirably affecting the amount of force needed to connect the electrical terminal to a mating electrical terminal. The electrical terminal includes a receptacle portion and a spring portion. The receptacle portion is formed from an electrically conductive material and includes an engagement arm having a support surface that defines a receptacle space. The spring portion is supported on the support surface of the engagement arm of the receptacle portion and is formed from an electrically conductive material. The spring portion includes a first end portion, a second end portion, and an intermediate portion extending between the first end portion and the second end portion. The intermediate portion includes a corrugation having alternating raised and lowered regions between the first and second end portions.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is an exploded perspective view of a first embodiment of an electrical terminal in accordance with this invention.

FIG. 2 is an enlarged perspective view of two generally planar springs of the first embodiment of the electrical terminal illustrated in FIG. 1.

FIG. 3 is an enlarged perspective view of the assembled first embodiment of the electrical terminal illustrated in FIGS. 1 and 2, together with a male blade terminal.

FIG. 4 is an enlarged end elevational view of the assembled first embodiment of the electrical terminal illustrated in FIG. 3.

FIG. 5 is a perspective view similar to FIG. 3 showing the male blade terminal after insertion within the assembled first embodiment of the electrical terminal.

FIG. 6 is an enlarged end elevational view showing the male blade terminal after insertion within the assembled first embodiment of the electrical terminal.

FIG. 7 is an exploded perspective view of a second embodiment of an electrical terminal in accordance with this invention.

FIG. 8 is an enlarged perspective view of a generally hollow cylindrical spring of the second embodiment of the electrical terminal illustrated in FIG. 7.

FIG. 9 is an enlarged sectional elevational view of the assembled second embodiment of the electrical terminal illustrated in FIGS. 7 and 8.

### DETAILED DESCRIPTION OF THE PREFERRED EMBODIMENTS

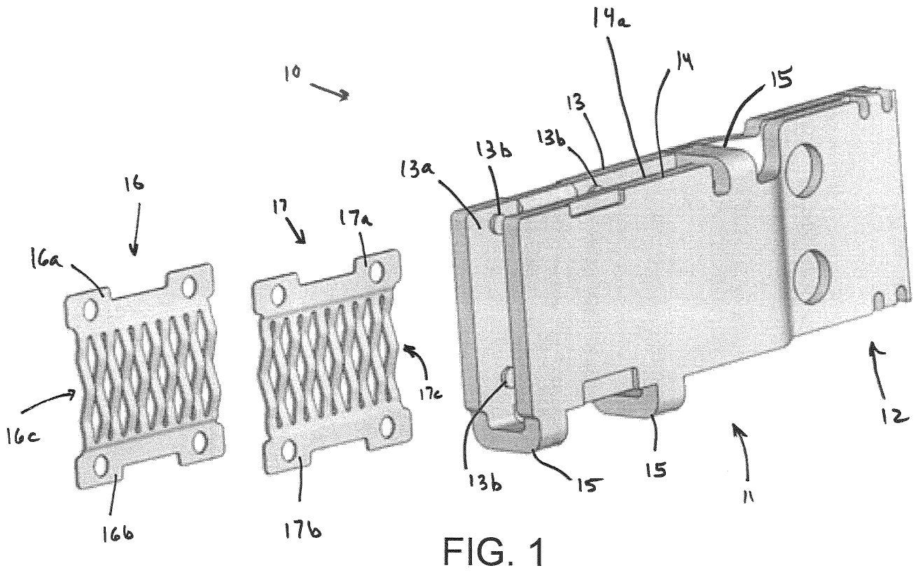

Referring now to the drawings, there is illustrated in FIGS. 1 through 6 a first embodiment of an electrical terminal, indicated generally at 10, for use in an electrical connector assembly in accordance with this invention. The illustrated electrical terminal 10 is a female electrical terminal that includes a receptacle portion, indicated generally at 11, which is structured and configured to receive a conventional male electrical terminal (not illustrated) as described below, and a connection portion, indicated generally at 12, which is structured and configured to be connected to a conventional electrical conductor (not illustrated). However, it will be appreciated that this invention may be used in conjunction with any other type of electrical terminals.

The receptacle portion 11 of the illustrated electrical terminal 10 includes a first engagement arm 13 having a support surface 13a from which one or more support protrusions 13b extend. In the illustrated embodiment, the support surface 13a is generally flat and planar in shape and has four generally cylindrically-shaped support protrusions 13b extending therefrom, although such is not required. Similarly, the illustrated receptacle portion 11 also includes a second engagement arm 14 having a support surface 14a from which one or more support protrusions 14b extend. In the illustrated embodiment, the support surface 14a is also generally flat and planar in shape and has four generally cylindrically-shaped support protrusions 14b extending therefrom, although again such is not required. The first and second support surfaces 13a and 14a are spaced apart from one another so as to define a receptacle space therebetween.

In the illustrated embodiment, the receptacle portion 11 of the electrical terminal 10 is formed from a single piece of an electrically conductive material that is bent or otherwise deformed to a desired configuration that includes some or all of the structures discussed above. To accomplish this, the receptacle portion 11 of the electrical terminal 10 may include one or more bridging portions 15 that extend between the first engagement arm 13 and the second engagement arm 14 to facilitate the manufacture thereof. However, the receptacle portion 11 may be formed from any desired number of pieces of material and in any desired manner.

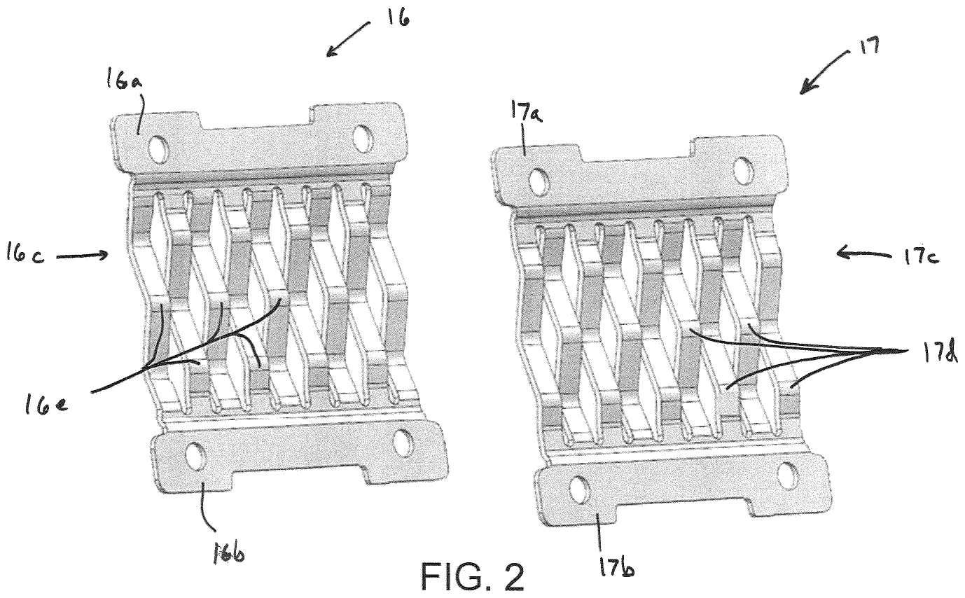

The receptacle portion 11 of the illustrated electrical terminal 10 also includes a first spring, indicated generally at 16, that is supported on the first engagement arm 13. The first spring 16 is formed from an electrically conductive material and includes first end portion 16a having a pair of openings extending therethrough, a second end portion 16b having a pair of openings extending therethrough, and an intermediate portion 16c extending between the first and second end portions 16a and 16b. As best shown in FIG. 2, the illustrated intermediate portion 16c includes nine separate corrugations, each of which is shaped having alternating raised and lowered regions between the first and second end portions 16a and 16b. As a result, each of the plurality of corrugated intermediate portions 16c defines one or more first contact points 16d that face toward the support surface 13a of the first engagement arm 13 and one or more second contact points 16e that face toward the support surface 14a of the second engagement arm 14. However, the intermediate portion 16c may be formed having a greater or lesser number of such corrugations having any desired shape or combination of shapes.

Referring back to FIG. 2, it can be seen that the corrugated intermediate portions 16c of the illustrated first spring 16 are arranged such that the first contact points 16d and the second contact points 16e alternate throughout both the length (i.e., in a first direction extending between the first and second end portions 16a and 16b) and the width (i.e., in a second direction extending perpendicular to the first direction) of the first spring 16. However, the corrugated intermediate portions 16c of the first spring 16 may be shaped in any other desired manner.

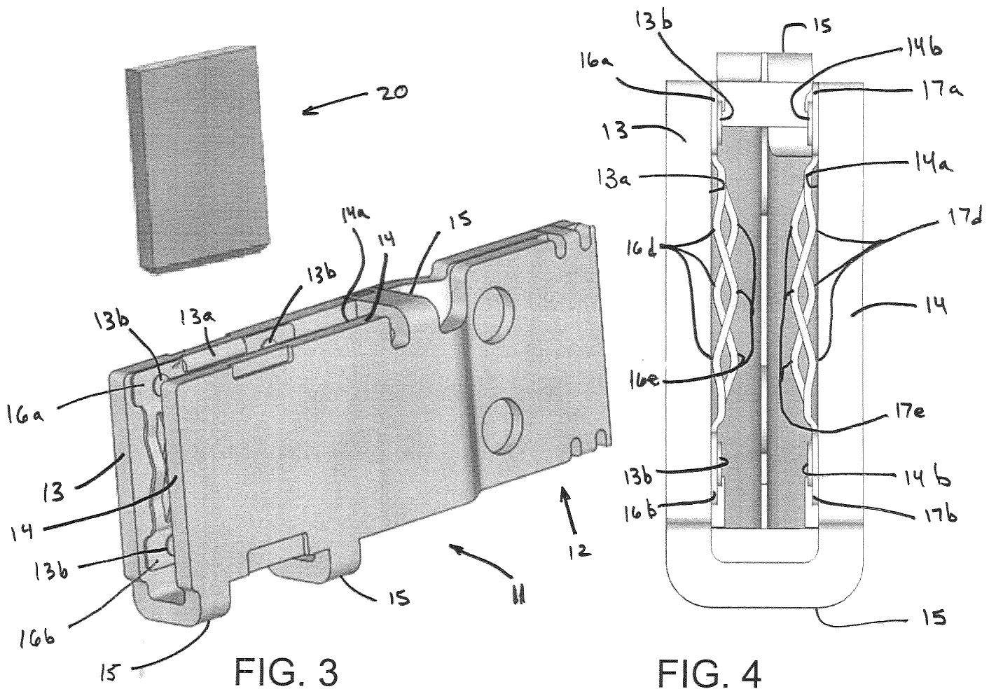

As best shown in FIGS. 3 through 6, the pair of openings extending through the first end portion 16a of the first spring 16 are sized and positioned to be received upon a first pair of the support protrusions 13b provided on the support surface 13a of the first engagement arm 13. Similarly, the pair of openings extending through the second end portion 16b of the first spring 16 are sized and positioned to be received upon a second pair of the support protrusions 13b provided on the support surface 13a of the first engagement arm 13. Thus, the first spring 16 can be supported on the first engagement arm 13 by inserting initially moving the first spring 16 within the receptacle space defined between the first and second engagement arms 13 and 14, and then moving the first spring 16 laterally such that the openings extending through the first and second end portions 16a and 16b are respectively received on the support protrusions 13b.

The receptacle portion 11 of the illustrated terminal 10 also includes a second spring, indicated generally at 17, that is supported on the second engagement arm 14. The second spring 17 is formed from an electrically conductive material and includes first end portion 17a having a pair of openings extending therethrough, a second end portion 17b having a pair of openings extending therethrough, and an intermediate portion 17c extending between the first and second end portions 17a and 17b. As best shown in FIG. 2, the illustrated intermediate portion 17c includes nine separate corrugations, each of which is shaped having alternating raised and lowered regions between the first and second end portions 17a and 17b. As a result, each of the plurality of corrugated intermediate portions 17c defines one or more first contact points 17d that face toward the support surface 14a of the second engagement arm 14 and one or more second contact points 17e that face toward the support surface 13a of the first engagement arm 13. However, the intermediate portion 17c may be formed having a greater or lesser number of such corrugations having any desired shape or combination of shapes.

Referring back to FIG. 2, it can be seen that the corrugated intermediate portions 17c of the illustrated second spring 17 are arranged such that the first contact points 17d and the second contact points 17e alternate throughout both the length (i.e., in a first direction extending between the first and second end portions 17a and 17b) and the width (i.e., in a second direction extending perpendicular to the first direction) of the second spring 17). However, the corrugated intermediate portions 17c of the second spring 17 may be shaped in any other desired manner.

As best shown in FIGS. 3 through 6, the pair of openings extending through the first end portion 17a of the second spring 17 are sized and positioned to be received upon a first pair of the support protrusions 14b provided on the support surface 14a of the second engagement arm 14. Similarly, the pair of openings extending through the second end portion 17b of the second spring 17 are sized and positioned to be received upon a second pair of the support protrusions 14b provided on the support surface 14a of the second engagement arm 14. Thus, the second spring 17 can be supported on the second engagement arm 14 by inserting initially moving the second spring 17 within the receptacle space defined between the first and second engagement arms 13 and 14, and then moving the second spring 17 laterally such that the openings extending through the first and second end portions 17a and 17b are respectively received on the support protrusions 14b.

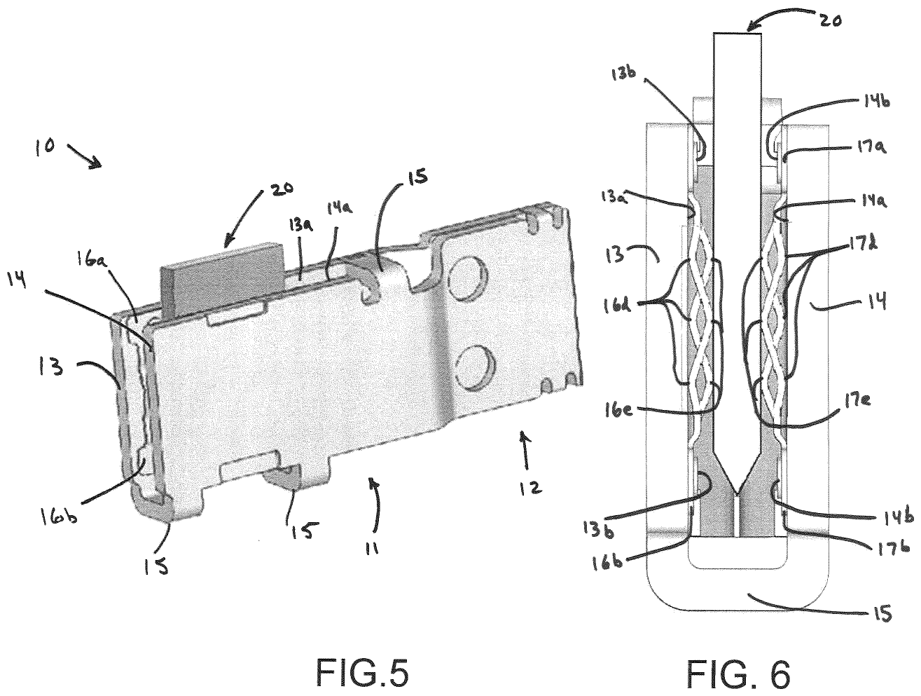

FIGS. 3 and 5 illustrate how a male blade terminal, indicated generally at 20, or similar electrical conductor can be connected to the first embodiment of the electrical terminal 10. Initially, as shown in FIG. 3, an end portion of the male blade terminal 20 is aligned with the receptacle space defined between the first and second engagement arms 13 and 14. Then, as shown in FIG. 5, the male blade terminal 20 is inserted into the receptacle space between the first and second springs 16 and 17. During such insertion, the male blade terminal 20 engages the second contact points 16e and 17e of the first and second springs 16 and 17, thereby compressing the first and second springs so as to exert respective retention forces on opposite sides of the male blade terminal 20. The staggered, multiple point contact of the male blade terminal 20 with the first and second springs 16 and 17 advantageously reduces the amount of resistance to the insertion of the male blade terminal into the electrical terminal 10. At the same time, the magnitude of such resistance is advantageously stable throughout the insertion process. Thus, the electrical terminal 10 is particularly well suited for conducting relatively high-magnitude electrical currents in the electrical system.

As mentioned above, the first embodiment of the electrical connector 10 may be supported within a housing (not shown) that is formed from an electrically non-conductive material so as to provide an electrical connector assembly. The housing of the electrical connector assembly may include one or more portions that mechanically engage and support an end of an electrical conductor to facilitate its connection (both mechanical and electrical) with the other components of the electrical system. If desired, a watertight seal may extend be provided on the housing of the electrical connector assembly for sealingly engaging the electrical conductor and the electrical terminal 10 supported therein.

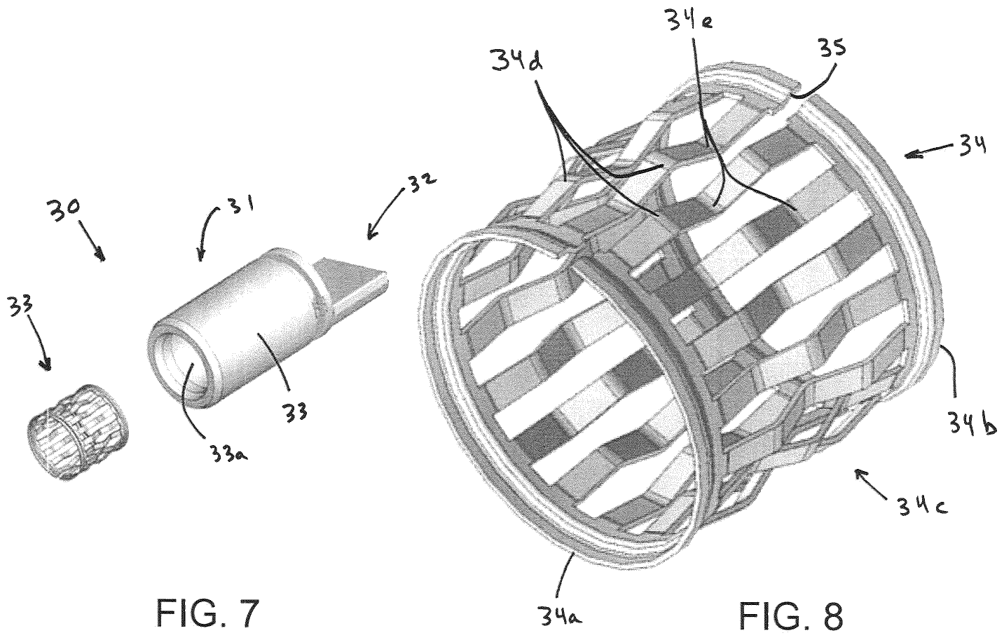

Referring now to FIGS. 7, 8, and 9, there is illustrated a second embodiment of an electrical terminal, indicated generally at 30, in accordance with this invention. The illustrated electrical terminal 30 is a female electrical terminal that includes a receptacle portion, indicated generally at 31, which is structured and configured to receive a conventional male electrical terminal (not illustrated) as described below, and a connection portion, indicated generally at 32, which is structured and configured to be connected to a conventional electrical conductor (not illustrated). However, it will be appreciated that this invention may be used in conjunction with male electrical terminals and with many other types of electrical terminals.

The receptacle portion 31 of the illustrated electrical terminal 30 includes a hollow cylindrical engagement arm 33 having an inner cylindrical support surface 33a. In the illustrated embodiment, the receptacle portion 31 of the electrical terminal 30 is formed from a single piece of an electrically conductive material that is bent or otherwise deformed to a desired configuration that includes some or all of the structures discussed above.

The receptacle portion 31 of the illustrated terminal 30 also includes a spring, indicated generally at 34, that is supported on the inner cylindrical support surface 33a thereof. The spring 34 is formed from an electrically conductive material and is generally hollow and cylindrical in shape, including a first end portion 34a, a second end portion 34b, and an intermediate portion 34c extending between the first and second end portions 34a and 34b. As best shown in FIG. 8, the illustrated intermediate portion 34c includes sixteen separate corrugations, each of which is shaped having alternating raised and lowered regions between the first and second end portions 34a and 34b. As a result, each of the plurality of corrugated intermediate portions 34c defines one or more first contact points 34d that face outwardly toward the support surface 33a of the first engagement arm 33 and one or more second contact points 34e that face inwardly away from the support surface 33a of the second engagement arm 14. However, the intermediate portion 16c may be formed having a greater or lesser number of such corrugations having any desired shape or combination of shapes. If desired, the spring 34 may include an axially-extending split 35 so that the spring 34 can resiliently engage the inner cylindrical support surface 33a of the engagement arm 33 in a known manner.

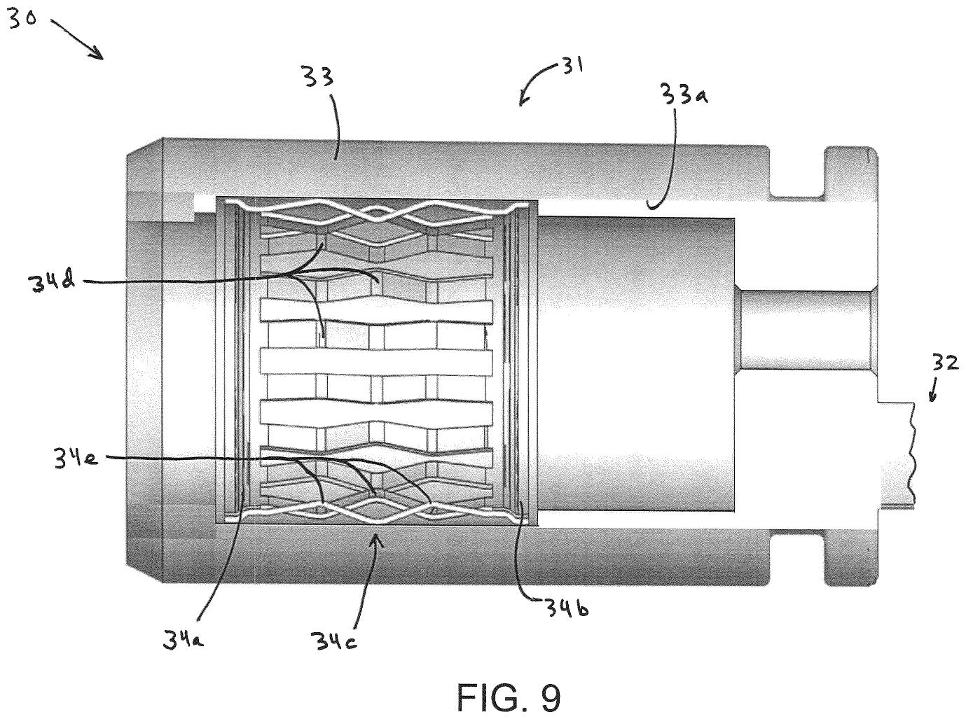

As best shown in FIG. 9, it can be seen that the corrugated intermediate portions 34c of the illustrated spring 34 are arranged such that the first contact points 34d and the second contact points 34e alternate throughout both the axial length and the radial extent of the spring 34). However, the corrugated intermediate portions 34c of the spring 34 may be shaped in any other desired manner. A male pin terminal (not shown) may be connected to the second embodiment of the electrical terminal 30 in a manner that is similar to the male blade terminal 20 described above. The staggered, multiple point contact of the male pin terminal with the spring 34 advantageously reduces the amount of resistance to the insertion of the male pin terminal into the electrical terminal 10. At the same time, the magnitude of such resistance is advantageously stable throughout the insertion process. Thus, the electrical terminal 10 is also particularly well suited for conducting relatively high-magnitude electrical currents in the electrical system.

The second embodiment of the electrical connector 30 may be supported within a housing (not shown) that is formed from an electrically non-conductive material so as to provide an electrical connector assembly. The housing of the electrical connector assembly may include one or more portions that mechanically engage and support an end of an electrical conductor to facilitate its connection (both mechanical and electrical) with the other components of the electrical system. A watertight seal may extend be provided on the housing of the electrical connector assembly for sealingly engaging the electrical conductor and the electrical terminal 30 supported therein.

The principle and mode of operation of this invention have been explained and illustrated in its preferred embodiments. However, it must be understood that this invention may be practiced otherwise than as specifically explained and illustrated without departing from its spirit or scope.

What is claimed is:

1. An electrical terminal for use in an electrical connector assembly, the electrical terminal comprising:
a receptacle portion formed from an electrically conductive material and including an engagement arm having a support surface that defines a receptacle space; and
a spring portion supported on the support surface of the engagement arm of the receptacle portion and formed from an electrically conductive material, the spring portion including a first end portion, a second end portion, and an intermediate portion extending between the first end portion and the second end portion, wherein the intermediate portion includes a corrugation having alternating raised and lowered regions between the first and second end portions.

2. The electrical terminal defined in claim 1 wherein the intermediate portion includes a plurality of corrugations, and wherein each of the plurality of corrugations as alternating raised and lowered regions between the first and second end portions.

3. The electrical terminal defined in claim 1 wherein the support surface of the engagement arm is generally planar in shape.

4. The electrical terminal defined in claim 1 wherein the support surface of the engagement arm is generally cylindrical in shape.

5. The electrical terminal defined in claim 1 wherein the receptacle portion includes first and second engagement arms having respective support surfaces that define the receptacle space, and wherein first and second spring portions are respectively supported on the first and second engagement arms of the receptacle portion.

6. The electrical terminal defined in claim 5 wherein each of the first and second spring portions includes a first end portion, a second end portion, and an intermediate portion extending between the first end portion and the second end portion, and wherein each of the corrugations the intermediate portion includes a corrugation having alternating raised and lowered regions between the first and second end portions.

7. The electrical terminal defined in claim 6 wherein each of the support surfaces of the engagement arms is generally planar in shape.

8. The electrical terminal defined in claim 1 further including a housing formed from an electrically non-conductive material, wherein the electrical terminal is supported within the housing to and provide an electrical connector assembly.
